(19) United States
(12) Patent Application Publication
(10) Pub. No.: US 2013/0290954 A1
(43) Pub. Date: Oct. 31, 2013

(54) Service provider-hosted virtual machine instantiation by hoster user for use by end users

(71) Applicants: Chia-Chu Sun Dorland, Folsom, CA (US); Pai Peng, Rocklin, CA (US)

(72) Inventors: Chia-Chu Sun Dorland, Folsom, CA (US); Pai Peng, Rocklin, CA (US)

(21) Appl. No.: 13/459,264

(22) Filed: Apr. 30, 2012

(51) Int. Cl. G06F 9/455

(52) U.S. Cl. 718/1

(57) ABSTRACT

A system includes one or more computing devices accessible over a network and managed by a service provider. A hoster user accessing the system over the network, and who is at least partially unaffiliated with the service provider, is permitted to instantiate in accordance with a desired configuration a virtual machine hosted at and realized by hardware resources of the computing devices. The hoster user is further permitted to assign one or more end users unaffiliated with the service provider to the virtual machine in accordance with a desired permission specified by the hoster user. The end users accessing the system over the network, and who are unaffiliated with the service provider, are permitted to access and use the virtual machine in accordance with the desired permission specified by the hoster user.

### BACKGROUND

Traditionally users used computers in non-collaborative contexts. For example, a user may use a computer to draft a letter, print the letter with a printer, and then send the letter. No one other than the user him or herself was involved in drafting the letter on the computer. More recently, users have begun to use computers in collaborative contexts. For example, a group of students may work on a school project together. Each student may be responsible for a different portion of an electronic presentation, for instance, that is then presented to classmates or the instructor.

### BRIEF DESCRIPTION OF THE DRAWINGS

FIG. 1 is a diagram of an example computer architecture in which virtual machines hosted by a system of a service provider are instantiated by a hoster user for usage by one or more end users.

FIG. 2 is a diagram of an example software implementation of the software that the service provider provides.

FIG. 3 is a diagram of an example conceptual model illustrating the relationship between the service provider, hosters, and the end users vis-à-vis the virtual machines that the system of the service provider hosts.

FIGS. 4, 5, 6, and 7 are diagrams of example user interfaces by which hoster users and end users can interact with the system of the service provider.

FIGS. 8 and 9 are flowcharts of example methods performed by the system of the service provider in interaction with hoster users and end users.

### DETAILED DESCRIPTION

As noted in the background section, computers are increasingly used by users in collaborative contexts in which groups of users may together work on a common project. Existing approaches to facilitate such collaboration include sharing files across isolated computing environments. For example, a user may work on a data file, save the data file, and then send it to other users for them to work on. Difficulties with such approaches include the users not having the same software to work on a common data file, as well as the potential for the data file to become compromised during transport or communication among the users, among other problems.

Techniques disclosed herein mitigate these issues. A hoster user accesses a system of computing devices managed by a service provider over a network to instantiate a virtual machine hosted at the system. The hoster user assigns end users to the virtual machine. The virtual machine is instantiated in accordance with a desired configuration specified by the hoster user, and the end users are assigned to the virtual machine in accordance with a desired permission also specified by the hoster user. The end users can then access and use the virtual machine over the network.

This approach permits the end users to share the same virtual machine to, for instance, work on a common data file in accordance with a shared project. Concerns over software incompatibility are avoided because the end users use their own computers just to access the computing devices on which the virtual machine is hosted; work on the data file itself is conducted within the auspices of the virtual machine. The data file does not have to be transported or communicated among the end users, either physically or electronically, because work on the data file by each user occurs at the virtual machine.

A virtual machine is a software implementation of a machine (i.e., a computer) that executes computer programs as if it were a physical machine. Unlike existing virtual machine management methodologies, the techniques disclosed herein are primarily focused on managing virtual machines that can each be shared by a group of users. The disclosed techniques also permit for instantiation of virtual machines even by a hoster user who may have limited technical ability, unlike existing virtual machine management techniques that usually are used by information technology (IT) administrators. The virtual machine management techniques disclosed herein are further provided in the context of a service provider of which the hoster user may be a customer or affiliated with a customer, as opposed to an employee of the service provider, for instance.

Before proceeding into the drawings, an example serves to illustrate the techniques disclosed herein. A group of students may be working on a group school project that is overseen by their instructor. The instructor, as a hoster user, logs onto a system managed by a service provider, and instantiates a virtual machine for the students to share. The instructor can configure the virtual machine to have just the software that the students are permitted to use to complete the project. The instructor can further accord the students with permissions that do not let them upload files to or download files from the virtual machine, to ensure that the students do not cheat or otherwise employ impermissible resources in completing the project.

As desired, the students can then log onto the service provider's system to access this virtual machine to complete the school project. This example serves to illustrate other advantages with the approaches disclosed herein. With the proliferation of electronically available resources, it is unfortunately not uncommon for students in particular to use the work of others as if it were their own. Because the instructor can configure a virtual machine so that the students cannot upload data files to the virtual machine or otherwise access external data files within the virtual machine, such improper usage is also greatly diminished.

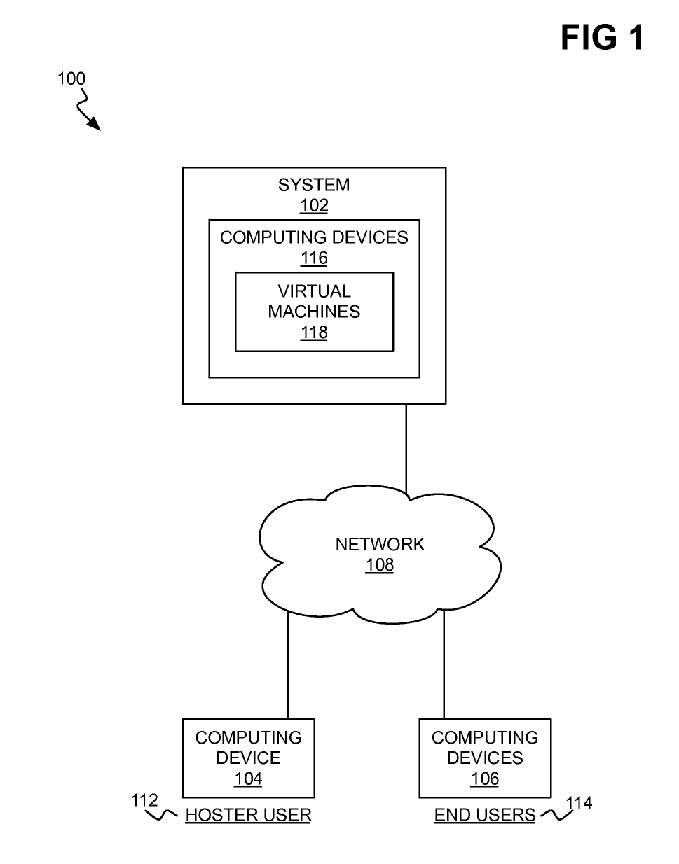

FIG. 1 shows an example computing architecture 100 including a system 102 and computing devices 104 and 106 interconnected via a network 108. The system 102 is under the auspices of a service provider 110, whereas the computing devices 104 and 106 are used by a hoster user 112 and end users 114, respectively. The network 108 may be or include the Internet, intranets, extranets, wired networks, wireless networks, telecommunications networks, and so on.

The service provider 110 manages and controls the system 102, which itself includes one or more computing devices 116, such as desktop computers, server computers, and the like. The computing devices 116 host one or more virtual machines 118 that are instantiated at the computing devices 116. As noted above, a virtual machine is a software implementation of a machine (i.e., a computer) that executes computer programs as if it were a physical machine. For instance, the computing devices 116 may have operating systems, and the virtual machines 118 are software implementations of computers running within these operating systems, and which have their own operating systems no differently than physical computing devices.

The hoster user 112 uses the computing device 104, which may be or include a desktop computer, a laptop computer, and so on, to access the system 102 run by the service provider 110 to instantiate the virtual machines 118. The end users 114 then use their computing devices 106, which may also be or include desktop computers, laptop computers, and the like, to access the system 102 to use the virtual machines 118. More specifics as to such usage are provided elsewhere in the detailed description.

However, in general, it is noted that the hoster user 112 typically instantiates the virtual machines 118 at the system 102 managed by the service provider 110 for particular usage by the end users 114. For example, the hoster user 112 may be a teacher, and the end users 114 may be students, such that the virtual machines 118 are instantiated for completion of a particular assignment. The end users 114 may be divided into one or more groups, where each such group shares a given virtual machine 118.

As another example, a software developer may instantiate a virtual machine 118 that prospective customers can access to try out software that the developer is developing. Because the software runs in the context of the virtual machine 118, the usage of which may be limited to running the software in question, the chances that a nefarious end user 114 will be able to pirate the software is significantly reduced. The software developer may instantiate more virtual machines 118 as needs dictate, and similarly may delete or remove virtual machines 118 as they go unused for various lengths of time.

The service provider 110 provides a platform as the system 102 by which the hoster user 112 is able to manage the virtual machines 118 even if the hoster user 112 has limited technical ability. That is, typically the person who manages virtual machines has to specify details such as the number of virtual or physical processors accorded to each virtual machine, the amount of memory, specifics as to guest operating system installed on each virtual machine, and so on. By comparison, such deployment details can be hidden from the hoster user 112. Rather, the hoster user 112 may be permitted to specify various levels of virtual machines 118 in easy to understand terminology such as “high performance suitable for gaming and intensive graphics”; “medium performance suitable for most office-oriented applications”; “low performance suitable for email, web browsing, and word processing”; and so on.

The relationship among the service provider 110, the hoster user 112, and the end users 114 is typically as follows. The service provider 110 is a technology company that provides for the ability of customers to instantiate and use the virtual machines 118. The hoster user 112 is affiliated with such a customer, which may be the employer of the hoster user 112, or the hoster user 112 may be a direct customer him or herself. In this respect, the hoster user 112 is at least partially unaffiliated with the service provider 110. That is, the hoster user 112 is not usually an employee of the service provider 110 itself, which is different than in conventional virtual machine environments in which the individual instantiating and managing virtual machines is such an employee.

The end users 114 are also unaffiliated with the service provider 110. In general, the end users 114 are not even customers (or employees) of the service provider 110. Rather, the end users 114 are affiliated or associated with the hoster user 112. For example, the hoster user 112 may be a manager at a corporation that is a customer of the service provider 110, and the end users 114 may be lower-level employees that report to the hoster user 112. As described above, the hoster user 112 may be a teacher, and the end users 114 may be his or her students.

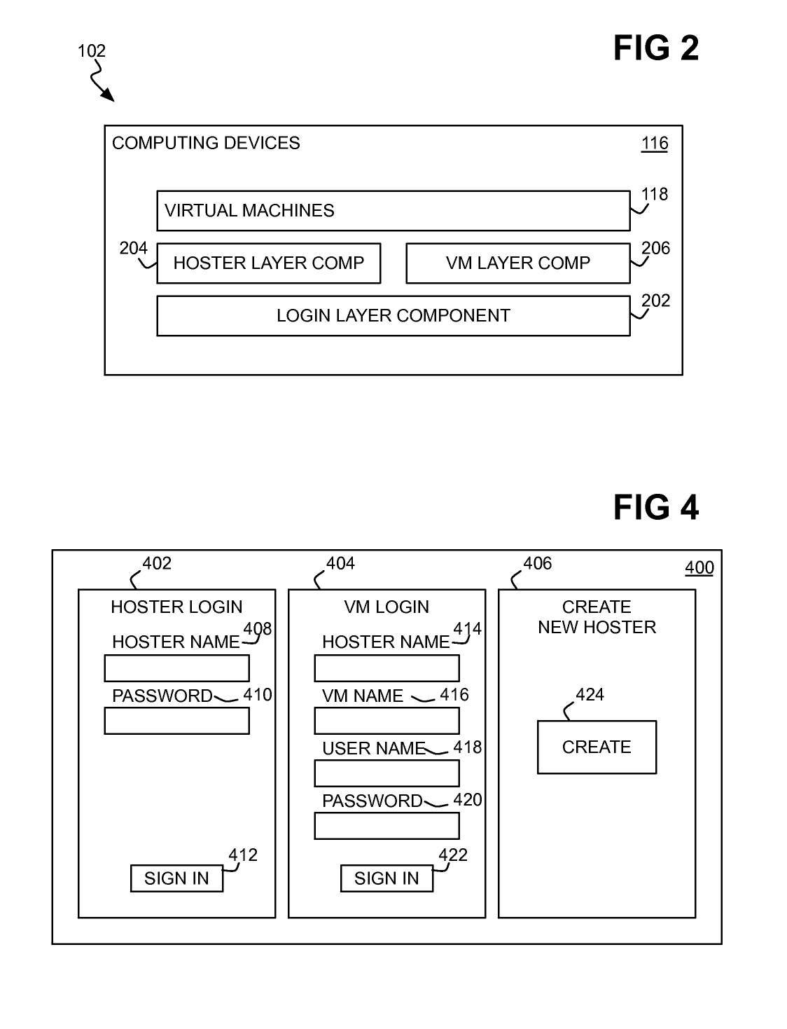

FIG. 2 shows an example implementation of the software that runs on the computing devices 116 of the system 102 provided by the service provider 110. This software includes the virtual machines 118, as well as at least three layer different layer components: a login layer component 202, a hoster layer component 204, and a virtual machine layer component 206. The layer components 202, 204, and 206 may each be a separate computer program, or may be different parts of the same computer program. The layer components 202, 204, and 206 are said to be implemented by the computing devices 116, insofar as they run on these devices 116.

The login layer component 202 governs access to the hoster layer component 204 and the virtual machine layer component 206 by the hoster user 112 and the end users 114. The hoster layer component 204 permits the hoster user 112 to instantiate in accordance with desired configurations the virtual machines 118 that are hosted at and realized by hardware resources of the computing devices 116, such as memory, processors, storage devices, and so on, of the devices 116. The hoster layer component 204 further permits the hoster user 112 to assign the end users 114 to the virtual machines 118 in accordance with desired permissions. The virtual machine layer component 206 thus permits the end users 114 to access and use the virtual machines 118 in accordance with these permissions specified by the hoster user 112.

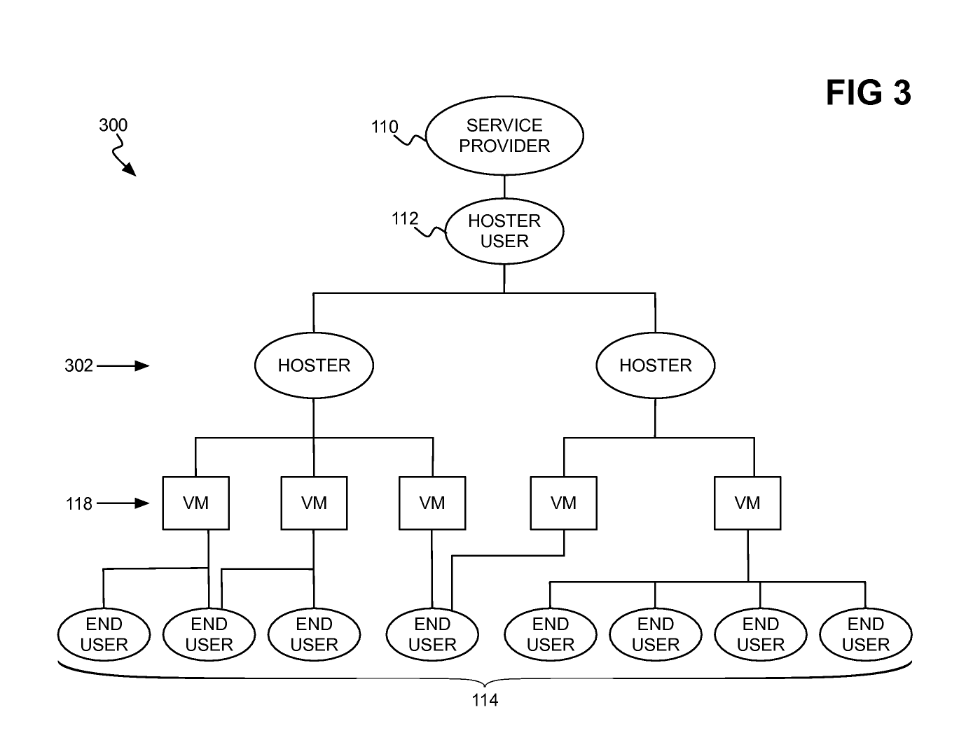

FIG. 3 shows an example model 300 that conceptually illustrates the relationship among the service provider 110, hosters 302 associated with one or more hoster users 112, and the end users 114 vis-à-vis the virtual machines 118. A number of hoster users 112 can be customers of or associated with customers of the service provider 110; in the example of FIG. 3, there is one hoster user 112. In general, each hoster user 112 is able to instantiate a number of virtual machines 118 that are hosted at the computing devices 116 of the system 102 of the service provider 110. The end users 114 affiliated with the hoster users 112 are able to access the virtual machines 118 to which the hoster users 112 have assigned them. A given virtual machine 118 may be assigned to one or more end users 114, and a given end user 114 may have more than one given virtual machine 118 assigned to him or her.

More specifically, a hoster user 112 is able to create one or more hosters 302 that are each associated with one or more virtual machines 118. A hoster 302 is a virtual container that is personal to a hoster user 112, and that host one or more virtual machines 118. As such, a hoster user 112 is able to segment the virtual machines 118 among different hosters 302 for organizational and other purposes. In the example of FIG. 3, the hoster user 112 has created two hosters 302, the left-most of which includes three virtual machines 118, and the right-most of which includes two virtual machines 118.

FIG. 4 shows an example user interface 400 that the login layer component 202 can expose over the network 108 to the hoster users 112 and the end users 114 at the computing devices 104 and 106. For instance, the user interface 400 may be provided as a part of a window of a web browser computer program running on one of the computing devices 104 and 106. As another example, the user interface 400 may be provided as part of a separate computer program, such as a particular “app” running on a tablet- or smartphone-type computing device.

The user interface 400 includes a hoster login area 402, an end user login area 404, and a new hoster creation area 406. The hoster login area 402 permits the hoster user 112 to provide a hoster identifier within a text box 408 and hoster authentication credentials within a text box 410 to access the hoster layer component 204. Once the hoster user 112 has input this information, he or she selects a button 412 to access the hoster layer component 204, assuming that the authentication credentials match what was previously provided for the hoster identifier. Because a given hoster user 112 can create more than one hoster 302, he or she may have multiple hoster identifiers and hoster authentication credentials for multiple hosters 302, and can log onto (and be logged onto) one particular hoster 302 at a time.

The end user login area 404 permits an end user 114 to provide a hoster identifier within the text box 414, a virtual machine identifier within the text box 416, an end user identifier within a text box 418, and end user authentication credentials within a text box 420. Once the end user 114 has input this information, he or she selects a button 422. The end user 114 is then permitted to access the virtual machine layer component 206, assuming that the information that the end user 114 has input is authenticated.

It is noted that the end user 114 has an end user identifier associated with the hoster identifier of a particular hoster 302; as such, the same end user identifier may nevertheless uniquely identify different end users 114 associated with different hosters 302 created by the same hoster user 112 or different hoster users 112. Furthermore, an end user 114 may be assigned to just particular virtual machines 118 that the hoster user 112 has instantiated within a particular hoster 302—specifically those that the hoster user 112 has assigned to the end user 114 in question for the particular hoster 302. This is why the end user 114 has to enter a hoster identifier and a virtual machine identifier in addition to his or her own end user identifier and end user authentication credentials to access the virtual machine 118 having the virtual machine identifier in question.

The new hoster creation area 406 permits a hoster user 112 to create a new hoster 302, by selecting a button 424, which may be cause another user interface to be displayed by which the new hoster 302 can be created. Once the new hoster 302 has been created, the hoster user 112 can then create virtual machines 118 associated with this hoster 302. Likewise, once the virtual machines 118 have been created and associated with the new hoster 302, the hoster user 112 can assign and un-assign end users 114 to and from the virtual machines 118.

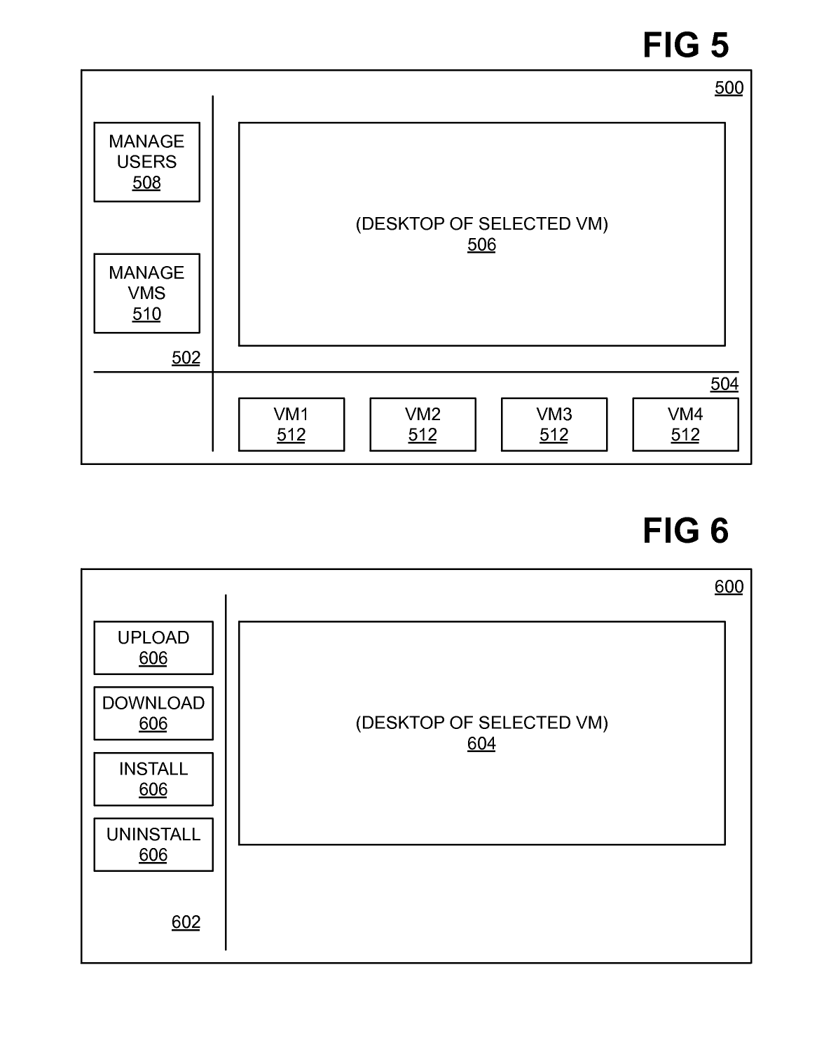

FIG. 5 shows an example user interface 500 that the hoster layer component 204 can expose over the network 108 to the hoster users 112 at computing devices 104, but not to the end users 114 at the computing devices 106. As with the user interface 400 of FIG. 4, the user interface 500 may be provided as a part of a window of a web browser computer program running on the computing devices 104. Similarly, as another example, the user interface 500 may be provided as part of a separate computer program, such as a particular “app” running on a tablet- or smartphone-type computing device.

The user interface 500 includes a management area 502, a virtual machine selection area 504, and a desktop region 506. The management area 502 includes graphical user interface elements 508 and 510, such as buttons, by which the hoster user 112 is permitted to manage the end users 114 and the virtual machines 118 of the hoster 302 that the hoster user 112 is currently logged onto. For instance, by selecting the user interface element 508, another user interface may be shown by which the hoster user 112 can add and remove end users 114, as well as modify assignments of the virtual machines 118 to the end users 114. The desired permissions of the end users 114 may also be modified by the hoster user 112, such as whether the end users 114 are permitted to upload files to and/or download files from the virtual machines 118, and whether the end users 114 are permitted to install software to and/or uninstall software from the virtual machines 118.

By selecting the user interface element 510, another user interface may be shown by which the hoster user 112 can create and delete the virtual machines 118 with respect to the hoster 302 that the hoster user 112 is currently logged onto. Selecting the user interface element 510 can permit the hoster user 112 to perform actions in relation to the virtual machines 118. For instance, the hoster user 112 may be able to upload files to and download files from the virtual machines 118, as well as install software to and uninstall software from the virtual machines 118. When the hoster user 112 is creating a new virtual machine 118, the hoster user 112 can be permitted to specify an operating system that is to run on the virtual machine 118, as well as preinstalled software that is to run on the virtual machine 118, which can be considered the desired configuration of this virtual machine 118.

The virtual machine selection area 504 includes graphical user interface element 512, such as buttons, by which the hoster user 112 is permitted to select a desired virtual machine 118. For instance, in one implementation, there may be a graphical user element 512 for each virtual machine 118 that the hoster user 112 has created and associated with the hoster 302 that the hoster user 102 is currently logged onto. The desktop region 506 shows the desktop, or screen, of the selected virtual machine 118. The hoster user 112 is thus able to view and use the virtual machine 118 that has been selected, no differently than if the virtual machine 118 were a physical computer in front of which the hoster user 112 was located.

Note in this respect that the hoster user 112 is able to access any virtual machine 118 of the hoster 302 that the hoster user 102 is currently logged onto and that he or she has created and assigned to one or more end users 114. The hoster user 112 can thus access data files that such end users 114 have created or modified within these virtual machines 118. Whereas end users 114 may be given limited permissions as to the activities they can perform within their assigned virtual machines 118, the hoster user 112 that created the virtual machines 118 has no such restrictions.

FIG. 6 shows an example user interface 600 that the virtual machine layer component 206 can expose over the network 108 to the end users 114 at the computing devices 106. As with the user interfaces 400 and 500 of FIGS. 4 and 5, the user interface 600 may be provided as a part of a window of a web browser computer program running on the computing devices 104. Similarly, as another example, the user interface 600 may be provided as part of a separate computer program, such as a particular “app” running on a tablet- or smartphone-type computing device.

The user interface 600 includes an actions area 602 and a desktop region 604. The desktop region 604 shows the desktop, or screen, of the virtual machine 118 that the end user 114 selected when logging on to the system 102. The end user 114 is thus able to view and use the virtual machine 118, no differently than if the virtual machine 118 were a physical computer in front of which the end user 114 was located. Usage of the virtual machine 118 is governed by the permissions that the hoster user 112 has accorded the end user 114 in relation to the virtual machine 118.

The actions area 602 includes graphical user interface elements 606, such as buttons, by which the end user 114 is to perform actions in relation to the virtual machine 118 as governed by the permissions that have been specified by the hoster user 112. For instance, the end user 114 may be able to upload files to and download files from the virtual machine 118. The end user 114 may further be able to install software to and uninstall software from the virtual machine 118. If the end user 114 is not permitted to do a given action corresponding to a particular graphical user interface element 606, the user interface element 606 in question may be grayed out so that the end user 114 cannot select it, or the element 606 may simply not be displayed within the actions area 602.

As such, the bounds by which the end users 114 are supposed to work within the virtual machine 118 can be ensured. As an example noted above, a number of students may be accorded access to the same virtual machine 118 to work on a school project together. The instructor may not want the students to be able to download or upload files to the virtual machine 118, to ensure that the students are doing original work. Therefore, by specifying the permissions for these end users 118 appropriately, the instructor can be certain that the students are not simply copying and pasting the existing work of others, for instance, within the school project. Once the project has been completed, the instructor him or herself can access the virtual machine 118 as the hoster user 112 to review the final result of the students' efforts.

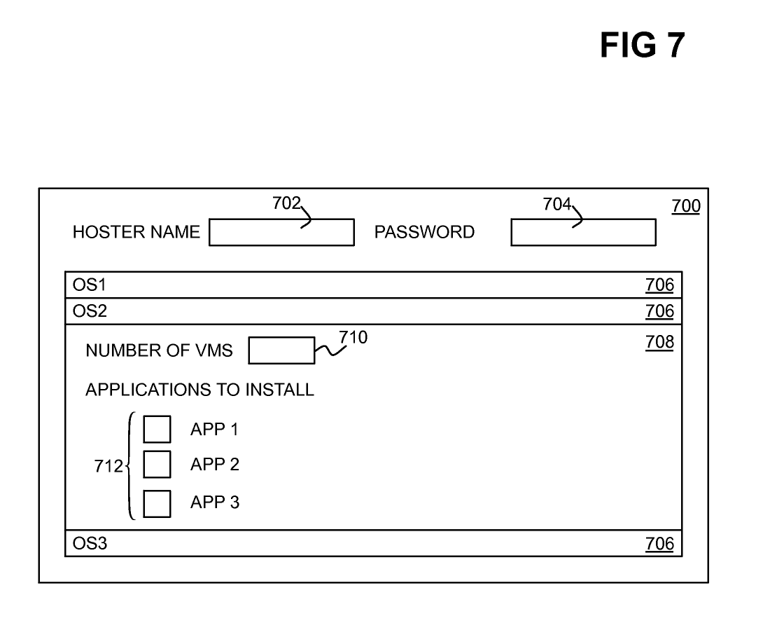

FIG. 7 shows an example user interface 700 that the hoster layer component 204 can expose over the network 108 to the hoster users 112 at the computing devices 104, but not to the end users 114 at the computing devices 106. As with the user interfaces 400, 500, and 600 of FIGS. 4, 5, and 6, the user interface 700 may be provided as part of a window of a web browser computer program running on the computing devices 104. As another example, the user interface 700 may be provided as part of a separate computer program, such as a particular “app” running on a tablet- or smartphone-type computing device.

The user interface 700 provides for the creation of new hoster 302 by a hoster user 112. The user interface 700 includes a text box 702 by which the hoster user 112 enters the hoster identifier of the new hoster 302 to be created. The user interface 700 also includes a text box 704 by which the hoster user 112 enters the hoster authentication credentials of the new hoster 302 to be created.

The user interface 700 includes a number of vertically arranged tabs 706 corresponding to the available operating system types and/or versions that can be preconfigured on virtual machines 118 to be instantiated and associated with the new hoster 302. In the example of FIG. 7, the hoster user 112 can select among three different types and/or versions of operating systems, because there are three tabs 706. The hoster user 112 can specify zero or more virtual machines 118 for each of these operating system types and/or versions.

The hoster user 112 selecting a tab 706 causes the user interface 700 to expose a pane 708 associated with this tab 706 and thus with the operating system type and/or version to which the selected tab 706 corresponds. In the example of FIG. 7, the middle tab 706 has been selected, such that the pane 708 displayed in FIG. 7 is for the operating system type and/or version to which the middle tab 706 corresponds. The pane 708 permits the hoster user 112 to enter the number of virtual machines 118 of the operating system type and/or version in question that are to be instantiated and associated with the new hoster 302, as well as the application computer programs to be installed on each such virtual machine 118.

As such, the pane 708 of the user interface 700 includes a text box 710 by which the hoster user 112 enters the number of virtual machines 118 in question. The pane 708 also includes one or more checkboxes 712 by which the hoster user 112 indicates which application computer programs are to be installed on each such virtual machine 118. There is a checkbox 712 for each application program that is available for installation. In the example of FIG. 7, the hoster user 117 can select up to three particular application computer programs to install, since there are three checkboxes 712.

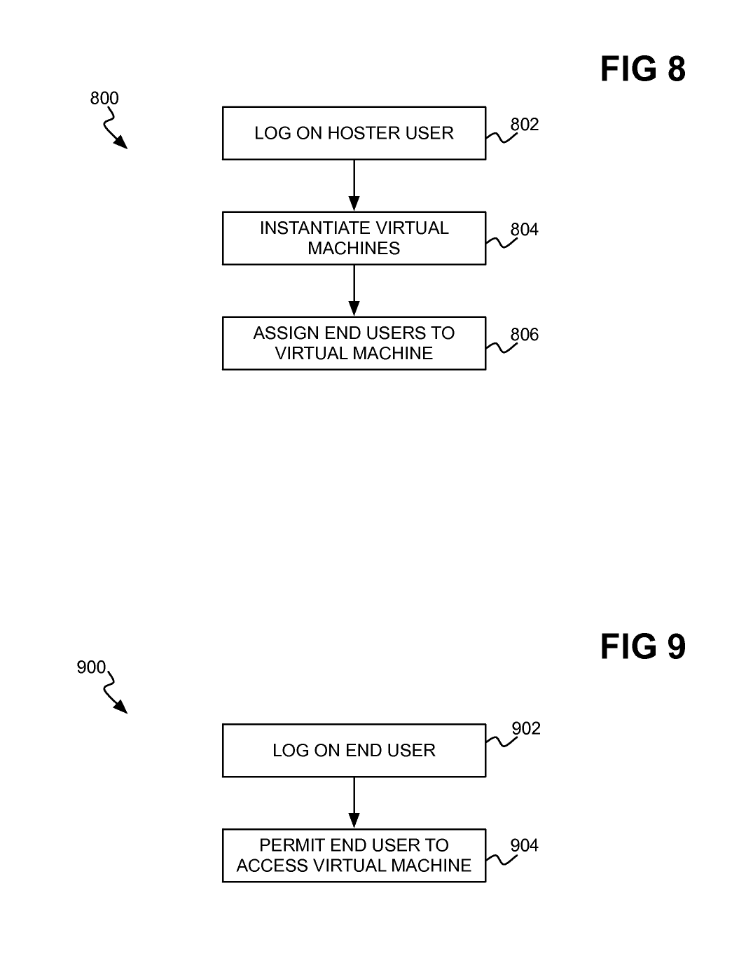

FIGS. 8 and 9 show example methods 800 and 900, respectively. The methods 800 and 900 can each be implemented as one or more computer programs executable by the computing devices 116 of the system 102 provided by the service provider 110. The method 800 relates to functionality performed within the system 102 in relation to the hoster user 112, whereas the method 900 relates to functionality performed within the system 102 in relation to the end users 114.

In the method 800, the system 102 logs on the hoster user 112 over the network 108 (802), such as via the computing device 104. As directed by the hoster user 112, the system 102 instantiates a virtual machine 118 in accordance with a desired configuration specified by the hoster user 112 over the network (804). The desired configuration can include the type of virtual machine 118, such as high performance, low performance, and so on, in relation to which appropriate hardware resources of the computing devices 116 are allocated to the virtual machine 118, as well as the guest operating system that the virtual machine 118 is to run.

As further directed by the hoster user 112, the system 112 assigns one or more end users 114 to the virtual machine 118 (806). Desired permissions can be specified for the end users 114 on an individual basis, as to what functionality the end users 114 are permitted to perform in relation to the virtual machine 118. As noted above, the end users 114 assigned to a virtual machine 118 can be changed as desired by the hoster user 112. Similarly, end users 114 can be created and deleted from the system 102. In each of the parts 802, 804, and 806 of the method 800, the system 102 can expose an appropriate user interface, examples of which have been described, to the hoster user 112 to assist the hoster user 112 in performing the desired functionality.

In the method 900, the system 102 logs on an end user 114 over the network 108 (902), such as via a computing device 106. The end user 114 specifies a virtual machine 118 to which he or she desires access. The system 102 interacts with the end user 114 to permit the end user 114 to access and use this virtual machine 118 (904). Such access and usage is in accordance with the desired permission specified by the hoster user 112 previously in relation to the end user 114 and the virtual machine 118 in question. In each of the parts 902 and 904 as well, the system 102 can expose an appropriate user interface, examples of which have been described, to the end user 114 to assist the end user 114 in performing the desired functionality.

We claim:

1. A system comprising:
one or more computing devices accessible over a network and managed by a service provider;
a hoster layer component implemented by the computing devices to permit a hoster user accessing the system over the network and who is at least partially unaffiliated with the service provider to instantiate in accordance with a desired configuration a virtual machine hosted at and realized by hardware resources of the computing devices and to assign one or more end users unaffiliated with the service provider to the virtual machine in accordance with a desired permission specified by the hoster user; and
a virtual machine layer component implemented by the computing devices to permit the end users accessing the system over the network and who are unaffiliated with the service provider to access and use the virtual machine in accordance with the desired permission specified by the hoster user.

2. The system of claim 1, further comprising a login layer component implemented by the computing devices to expose a user interface over the network to the hoster user and to the end users, the user interface providing:
a hoster login area by which the hoster user provides a hoster identifier and hoster authentication credentials to access the hoster layer component; and
an end user login area by which the end users provide the hoster identifier, a virtual machine identifier, one or more end user identifiers, and end user authentication credentials to access the virtual machine layer component.

3. The system of claim 1, wherein the hoster layer component is expose a user interface over the network to the hoster user, the user interface providing:
one or more management graphical user interface elements by which the hoster user is permitted to create the virtual machine and delete the virtual machine, and to add the end users and delete the end users;
a selection graphical user interface element to select the virtual machine; and
a desktop region by which the hoster user is able to view and use the virtual machine that has been selected within the selection graphical user interface element.

4. The system of claim 3, wherein the management graphical user interface elements further permit the hoster user to upload files to and download files from the virtual machine, and install software to and uninstall software from the virtual machine.

5. The system of claim 3, wherein the management graphical user interface elements further permit the hoster user to, when creating the virtual machine, specify an operating system and preinstalled software of the virtual machine as the desired configuration.

6. The system of claim 1, wherein the virtual machine layer component is to expose a user interface over the network to the end users, the user interface providing:
a desktop region by which the end users are able to view and use the virtual machine in accordance with the desired permission specified by the hoster user; and
one or more action graphical user interface elements by which the end users are permitted to perform actions in relation to the virtual machine as governed by the desired permission specified by the hoster user.

7. The system of claim 6, wherein the action graphical user interface elements permit the end users to, insofar as the desired permission allows, to upload files to and download files from the virtual machine, and install software to and uninstall software from the virtual machine.

8. The system of claim 1, wherein the virtual machine is a given virtual machine of a plurality of virtual machines instantiated by the hoster user.

9. The system of claim 1, wherein the hoster user is at least partially unaffiliated with the service provider in that the hoster user is not employed by but rather is a customer of or is affiliated with a customer of the service provider,
and wherein the end users are unaffiliated with the server provider in that the end users are not employed by the service provider but rather are affiliated with the hoster user.

10. A method comprising:
logging on a hoster user over a network to a system including one or more computing devices managed by a service provider, the hoster user at least partially unaffiliated with the service provider;
instantiating a virtual machine hosted at and realized by hardware resources of the computing devices in accordance with a desired configuration specified by the hoster user over the network; and
assigning one or more end users unaffiliated with the service provider, as specified by the hoster user over the network, to the virtual machine in accordance with a desired permission specified by the hoster user over the network.

11. The method of claim 10, wherein logging on the hoster user comprises exposing a user interface over the network to the hoster user, the user interface providing a hoster login area by which the hoster user provides a hoster identifier and hoster authentication credentials to log on.

12. The method of claim 10, wherein instantiating the virtual machine and assigning the end users to the virtual machine comprise exposing a user interface over the network to the hoster user, the user interface providing:
one or more management graphical user interface elements by which the hoster user is permitted to create the virtual machine and delete the virtual machine;
a selection graphical user interface element to select the virtual machine; and
a desktop region by which the hoster user is able to view and use the virtual machine that has been selected within the selection graphical user interface element.

13. A non-transitory computer readable storage medium storing a computer program executable by one or more computing devices accessible over a network and managed by a service provider, execution of the computer program causing a method to be performed, the method comprising:
logging on one or more end users over a network to a system including the computing devices, the end users unaffiliated with the service provider; and
interacting with the end users over the network to permit the end users to access and use a virtual machine over the network in accordance with a desired permission specified by a hoster user who is at least partially unaffiliated with the service provider, who caused instantiation of the virtual machine in accordance with a desired configuration specified by the hoster user, and who caused assignment of the end users to the virtual machine.

14. The non-transitory computer readable storage medium of claim 13, wherein logging on the end users comprises exposing a user interface over the network to the end users, the user interface providing an end user login area by which the end users provide the hoster identifier, a virtual machine identifier, one or more end user identifiers, and end user authentication credentials to log on.

15. The non-transitory computer readable storage medium of claim 13, wherein interacting with the end users comprises exposing a user interface over the network to the end users, the user interface providing:
a desktop region by which the end users are able to view and use the virtual machine in accordance with the desired permission specified by the hoster user; and
one or more action graphical user interface elements by which the end users are permitted to perform actions in relation to the virtual machine as governed by the desired permission specified by the hoster user.
